(19) United States
(12) Patent Application Publication
(10) Pub. No.: US 2012/0085475 A1
(43) Pub. Date: Apr. 12, 2012

(54) PNEUMATIC TIRE WITH A KNITTED FLIPPER

(76) Inventors: Annette Lechtenboehmer, Ettelbruck (LU); David Gilbert Wieczorek, Bridel (LU); Raphael Beck, Reichlange (LU)

(21) Appl. No.: 12/899,803

(22) Filed: Oct. 7, 2010

(51) Int. Cl. B60C 15/06

(52) U.S. Cl. 152/540; 152/542

(57) ABSTRACT

A pneumatic tire includes an axis of rotation, a carcass, a tread disposed radially outward of the carcass, a belt structure disposed radially between the carcass and the tread, and a reinforcing structure providing a buffer for absorbing shear strain. The reinforcing structure includes a layer of a knitted fabric. The layer includes first yarns and second yarns.

### FIELD OF THE INVENTION

The present invention relates to a pneumatic tire, and more particularly, to a radial pneumatic tire with a unique flipper.

### BACKGROUND OF THE INVENTION

A pneumatic tire typically includes a pair of axially separated inextensible beads. A circumferentially disposed bead filler apex extends radially outward from each respective bead. At least one carcass ply extends between the two beads. The carcass ply has axially opposite end portions, each of which is turned up around a respective bead and secured thereto. Tread rubber and sidewall rubber is located axially and radially outward, respectively, of the carcass ply.

The bead area is one part of the tire that contributes a substantial amount to the rolling resistance of the tire, due to cyclical flexure which also leads to heat buildup. Under conditions of severe operation, as with runflat and high performance tires, the flexure and heating in the bead region can be especially problematic, leading to separation of mutually adjacent components that have disparate properties, such as the respective moduli of elasticity. In particular, the ply turnup ends may be prone to separation from adjacent structural elements of the tire.

A conventional ply may be reinforced with materials such as nylon, polyester, rayon, and/or metal, which have much greater stiffness (i.e., modulus of elasticity) than the adjacent rubber compounds of which the bulk of the tire is made. The difference in elastic modulus of mutually adjacent tire elements may lead to separation when the tire is stressed and deformed during use.

A variety of structural design approaches have been used to control separation of tire elements in the bead regions of a tire. For example, one method has been to provide a “flipper” surrounding the bead and the bead filler. The flipper works as a spacer that keeps the ply from making direct contact with the inextensible beads, allowing some degree of relative motion between the ply, where it turns upward under the bead, and the respective beads. In this role as a spacer, a flipper may reduce disparities of strain on the ply and on the adjacent rubber components of the tire (e.g., the filler apex, the sidewall rubber, in the bead region, and the elastomeric portions of the ply itself).

The flipper may be made of a square woven cloth that is a textile in which each fiber, thread, or cord has a generally round cross-section. When a flipper is cured with a tire, the stiffness of the fibers/cords becomes essentially the same in any direction within the plane of the textile flipper.

In addition to the use of flippers as a means by which to reduce the tendency of a ply to separate, or as an alternative, another method that has been used involves the placement of “chippers.” A chipper is a circumferentially deployed metal or fabric layer that is disposed within the bead region in the portion of the tire where the bead fits onto the wheel rim. More specifically, the chipper lies inward of the wheel rim (i.e., toward the bead) and outward (i.e., radially outward, relative to the bead viewed in cross section) of the portion of the ply that turns upward around the bead. Chippers serve to stiffen, and increase the resistance to flexure of, the adjacent rubber material, which itself is typically adjacent to the turnup ply endings.

### SUMMARY OF THE INVENTION

A pneumatic tire in accordance with the present invention includes an axis of rotation, a carcass, a tread disposed radially outward of the carcass, a belt structure disposed radially between the carcass and the tread, and a reinforcing structure providing a buffer for absorbing shear strain. The reinforcing structure includes a layer of a knitted fabric. The layer includes first yarns and second yarns.

In one aspect of the present invention, the reinforcing structure of the carcass is a flipper.

In another aspect of the present invention, the flipper separates a reinforced ply of the carcass from a bead of the carcass.

In still another aspect of the present invention, the flipper acts as a strain-relieving layer between the bead and the reinforced ply.

In yet another aspect of the present invention, the fabric has a 5 EPI to 18 EPI construction.

In still another aspect of the present invention, the first yarns are 940/1 dtex aramid and the second yarns are 1220/1 dtex rayon.

In yet another aspect of the present invention, the first yarns have a density of 14 EPI and the second yarns have a density of 12 EPI.

In still another aspect of the present invention, the pneumatic tire is a radial runflat passenger tire.

In yet another aspect of the present invention, the pneumatic tire is a high performance tire.

In still another aspect of the present invention, the layer further comprises an adhesion promoter disposed thereon.

In yet another aspect of the present invention, the reinforcing structure of the carcass is a flipper having two or more layers.

In still another aspect of the present invention, the flipper includes a layer of rubber between the fabric layers.

In yet another aspect of the present invention, the first yarns comprise at least two fibers of different fiber materials.

In still another aspect of the present invention, the second yarns comprise at least two fibers of different fiber materials.

In yet another aspect of the present invention, the first yarns extend circumferentially and radially at an angle of 30 degrees to 55 degrees relative to the radial direction of the tire.

In still another aspect of the present invention, the reinforcing structure separates a reinforced ply of the carcass from a bead of the carcass, the reinforcing structure terminating within an apex of the pneumatic tire.

### DEFINITIONS

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density). Dtex means the weight in grams per 10,000 meters.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa@ 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Mega Tensile Steel (MT)” means a carbon steel with a tensile strength of at least 4500 MPa@0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa@0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Super Tensile Steel (ST)” means a carbon steel with a tensile strength of at least 3650 MPa@0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa@0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### BRIEF DESCRIPTION OF THE DRAWINGS

The structure, operation, and advantages of the invention will become more apparent upon contemplation of the following description taken in conjunction with the accompanying drawings, wherein:

FIG. 1 represents a schematic cross-sectional view of an example tire for use with the present invention;

FIG. 2 represents a schematic detail view of the bead region of the example tire shown in FIG. 1;

FIG. 3 represents a schematic detail view of another bead region for use with present invention; and

FIG. 4 represents a schematic detail of an example fabric in accordance with the present invention.

### DETAILED DESCRIPTION OF AN EXAMPLE EMBODIMENT

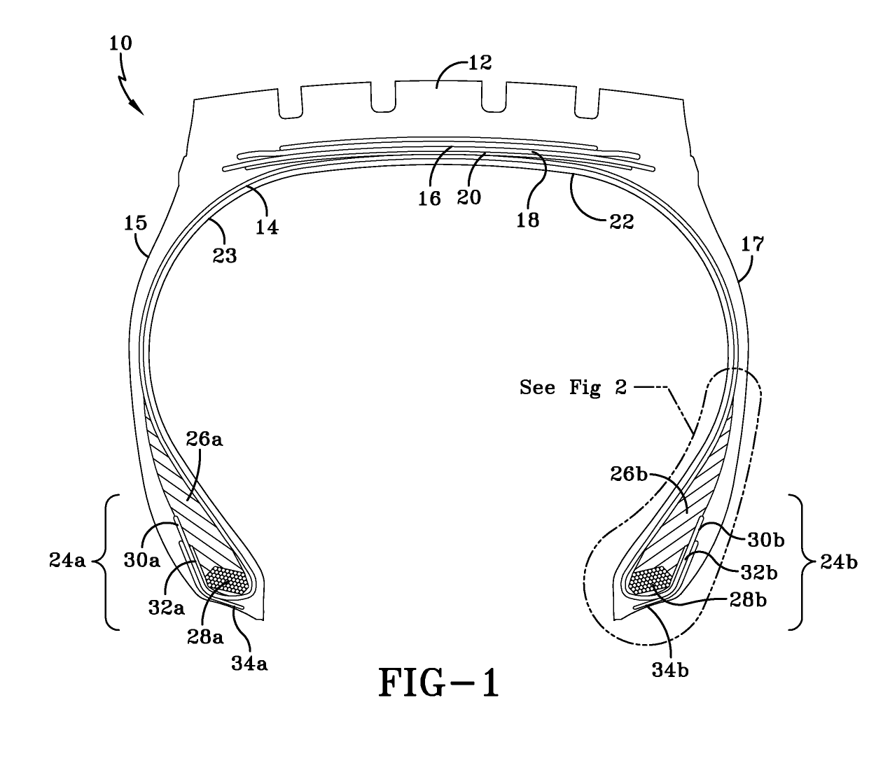

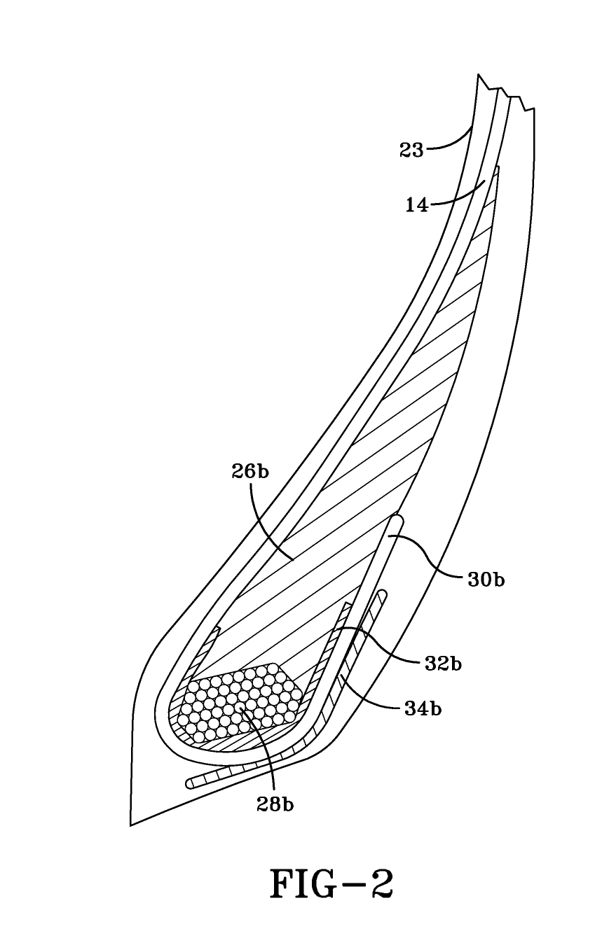

FIG. 1 shows an example tire 10 for use with reinforcing structures, such as flippers, in accordance with the present invention. The example tire 10 has a tread 12, an inner liner 23, a belt structure 16 comprising belts 18, 20, a carcass 22 with a single carcass ply 14, two sidewalls 15,17, and two bead regions 24a, 24b comprising bead filler apexes 26a, 26b and beads 28a, 28b. The example tire 10 is suitable, for example, for mounting on a rim of a passenger vehicle. The carcass ply 14 includes a pair of axially opposite end portions 30a, 30b, each of which is secured to a respective one of the beads 28a, 28b. Each axial end portion 30a or 30b of the carcass ply 14 is turned up and around the respective bead 28a, 28b to a position sufficient to anchor each axial end portion 30a, 30b, as seen in detail in FIGS. 1 and 2.

The carcass ply 14 may be a rubberized ply having a plurality of substantially parallel carcass reinforcing members made of such material as polyester, rayon, or similar suitable organic polymeric compounds. The carcass ply 14 engages the axial outer surfaces of two flippers 32a, 32b and the axial inner surfaces of two chippers 34a, 34b.

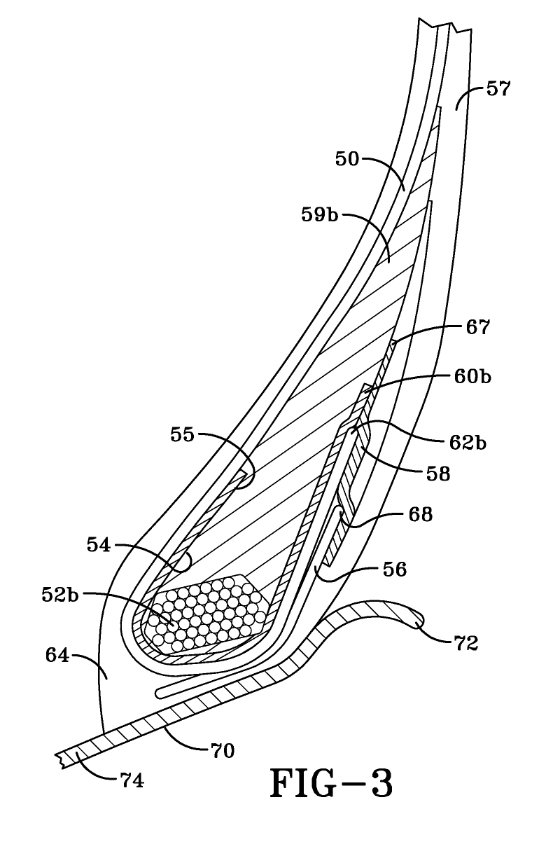

FIG. 3 shows, in cross-sectional view, the bead region of another example tire for use with reinforcing structures, such as flippers, in accordance with the present invention. A carcass ply 50 wraps around a bead 52b and is separated from the bead by a flipper 54. The flipper 54 may be a layer of knitted fabric disposed around the bead 52b and inward of a portion of the carcass ply 50 which turns up under the bead. The knitted fabric flipper 54 may have physical properties (such as shearing modulus of elasticity) intermediate to those of a rigid metal bead 52b and a less rigid carcass ply 50. The knitted fabric flipper 54 therefore may serve as an active strain-relieving layer separating the bead 52b from the carcass ply 50. The carcass ply 50 may be reinforced with metal, as is conventional in the tire art.

The example tire of FIG. 3 also may have a fabric chipper 56 located in the bead area for reinforcing the bead area and stabilizing the axially inwardmost part of the sidewall 57. The flipper 54 and chipper 56, along with the patch 58 uniting them, are discussed separately below, and then in operational conjunction with one another.

The knitted fabric flipper 54 wraps around the bead 52b and extends radially outward into the sidewall regions of the example tire. The axially inward portion 55 of knitted fabric flipper 54 terminates within the bead-filler apex 59b. The axially outward portion 60b of the knitted fabric flipper 54 lies radially beyond a turnup end 62b, which itself is located radially beyond the radially outermost reach of the chipper 56 (discussed separately below). The axially outwardmost portions of the turnup end 62b of the carcass ply 50 may extend radially outward about 15-30 millimeters beyond the top of a wheel rim flange 72 of a wheel rim 70.

As shown in FIG. 3, the knitted fabric flipper 54 is deployed about the bead 52b which is itself circumferentially disposed within the example tire. An axially inward portion 55 of the knitted fabric flipper 54 extends radially outward from the bead 52b to a location approximately axially adjacent to the top of the wheel rim flange 72 of the wheel rim 70. On an axially outward side, the knitted fabric flipper 54 extends radially outward from the bead 52b to an end 60b above the wheel rim flange 72. The radially outermost reach of the end 60b of the knitted fabric flipper 54 may extend between about 7-15 millimeters beyond the radially outermost reach of the turnup end 62b. The knitted fabric flipper 54 may be termed “active” because it actively absorbs (i.e. during tire deflection) differential strains between the relatively rigid bead 52b and the relatively less rigid carcass ply 50.

The chipper 56 is disposed adjacent to the portion of the carcass ply 50 that is wrapped around the bead 52b. More specifically, the chipper 56 is disposed on the opposite side of the portion of the carcass ply 50 from the knitted fabric flipper 54. The axially inwardmost portion of the knitted fabric chipper 56 lies in the portion of the bead region that, when the tire is mounted on the wheel rim 70, would lie closest to a circularly cylindrical part 74 of the wheel rim. The axially and radially outwardmost portion of the chipper 56 lies in the portion of the bead region that, when the tire is mounted on the wheel rim 70, would lie axially inward of the circular portion of the wheel rim 70, being separated from the circular portion of the wheel rim by tire rubber such as a toe guard 64.

In other words, as can be seen in FIG. 3, the chipper 56 is disposed circumferentially about the radially inwardmost portion of the carcass ply 50 where the carcass ply turns up under the bead 52b. The chipper 56 may extend radially outward, being more or less parallel with the turned up end 62b of the carcass ply 50.

The chipper 56 may protect the portion of the carcass ply 50 that wraps around the bead 52b from the strains in the rubber that separates the chipper from the wheel rim 70. The chipper 56 reinforces the bead area and stabilizes the radially inwardmost part of the sidewall 57. In other words, the chipper 56 may absorb deformation in a way that minimizes the transmission of stress-induced shearing strains that arise inward from the wheel rim 70, through the toe guard 64, to the turned up portion 62b of the carcass ply 50, where the chipper is most immediately adjacent to the rigid bead 52b.

The patch 58 shown in FIG. 3 is circumferentially disposed about the bead 52b in such a way as to overlie the radially outermost regions 68 of the chipper 56 and the turned up ends 62b of the carcass ply 50. The patch 58 performs a function similar to that of those of the chipper 56 and the knitted fabric flipper 54. More specifically, the patch 58 may absorb shearing stresses in the rubber parts which might otherwise induce separation of the flexible rubber from the less flexible material of the chipper 56 and the carcass ply 50. The patch 58 may, for example, be made of nylon fabric. The radially outwardmost portion 67 of the patch 58 may reach to a minimum level such as extending by at least 5 mm above the upper end 60b of the knitted fabric flipper 54, and preferably 10-15 mm above. The radially inwardmost portion of the patch 58 may overlap about 10 mm with the chipper 56.

The net effect of the incorporation of the knitted fabric flipper 54 is to provide a strain buffer that relieves or absorbs differential shearing strains that otherwise, were the flippers not present, could lead to separation of the adjacent materials that have disparate shearing moduli of elasticity. Furthermore, this reinforced construction may increase durability of the tire by means of the incorporation of a smaller number of components than for standard constructions with gum strips.

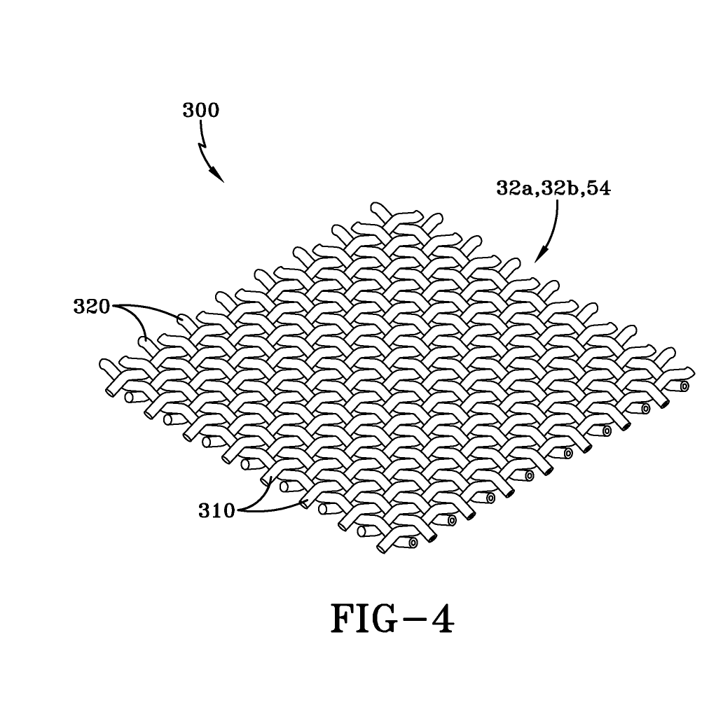

In accordance with the present invention, the knitted fabric flippers 32a, 32b, 54 of the example tires of FIGS. 1-3 may comprise knitted fabric. As illustrated in the example of FIG. 4, a flipper 54 may comprise a layer 300 of knitted fabric having a first set of yarns 310 interlaced with a second set of yarns 320.

The layer 300 of the knitted fabric flippers 32a, 32b, 54 may be made of a highly deformable elastic knitted fabric of low apparent density, allowing elasticity due to sliding of the threads and the deformation of the stitches. The construction of the layer 300 may further allow some degree of mechanical decoupling between the different yarns 310, 320 thereby providing structural flexibility in adapting to the deformations of the tire 10 during use. Various kinds of material may be selected to produce this layer 300. Thickness, proportion of voids, and density may be directly related to the material and the structure of the knitted fabric layer 300 (thread diameter, number of stitches per dm, tightness).

The layer 300 may thus define a bielastic fabric having an elastic elongation ratio of at least 8% and a stitch size of less than or equal to 150 stitches per decimeter. The layer may be constructed of synthetic fibers, natural fibers, and/or a blend of these fibers. The layer 300 may comprise polyamides, polyesters, rayon, cotton, wool, aramid, silk and/or flax.

A proportion of elastic threads such as polyurethane, latex, natural, or synthetic rubber may be useful to provide the elastic return, which aids in application of the fabric. Thus, as an example, the bielastic/knitted fabric flipper 32a, 32b, 54 in accordance with the present invention, may have a thickness from 0.2 mm to 2 mm and a mass per unit area from 70 to 700 g/m². Further, the bielastic/knitted fabric flipper 32a, 32b, 54 may have a density from 0.02 g/cm³ to 0.50 g/cm³.

Additionally, the bielastic/knitted fabric flipper 32a, 32b, 54 may have a void volume of at least 40% so that the knitted fabric will be sufficiently compressible. The void volume may be calculated by comparing the density of the knitted fabric with that of the compact material forming its matrix, measured by any suitable.

Non-elastomeric materials may also be used for the matrix of the bielastic/knitted fabric flipper 32a, 32b, 54, including natural textile fibers such as cotton, wool, flax, hemp, silk, etc., artificial textile fibers such as rayon, synthetic textile fibers such as polyester, polyvinyl acetate, nylon (including nylon 6, nylon 6,6, and nylon 4,6), polyethylene naphthalate (PEN), rayon, polyketone, PBO polyimide, aramid, polyvinyl chloride, polyolefins, etc., and/or mineral fibers such as glass, carbon, silica, mineral wool, etc. The elastomeric material may be natural rubber, polybutadiene, SBR, polyurethane, etc.

The yarns 310, 320 may be a spun staple yarn, a multifilament yarn, and/or a monofilament yarn formed of a suitable material. The yarns 310, 320 may also be hybrid yarns. Hybrid yarns may be multiply yarns, made up of at least 2 fibers of different material (for example, cotton and nylon). These different fiber materials may produce hybrid yarns with various chemical and physical properties. Hybrid yarns may be able to change the physical properties of the final product in which they are used. Example hybrid yarns may be an aramid fiber with a nylon fiber, an aramid fiber with a rayon fiber, and an aramid fiber with a polyester fiber.

As used herein, mechanical resiliency of a yarn is the ability of the yarn to displace longitudinally without an elastic deformation of the material. Mechanical resiliency allows the knitted fabric layer 300 to have a minor amount of resilient elongation for compatibility with the example tires of FIGS. 1-3, but use stronger yarns in the flipper 32a, 32b, 54.

The knitted fabric layer 300 is an open construction fabric which permits the strike through of rubber in a tire for a better bonded construction. The openness of the fabric used for the layer 300 is usually determined by the spacing and character of the yarns 310, 320.

The layer 300 may be treated with an adhesion promoter. Examples of adhesion promoters include resorcinol formaldehyde latex (RFL), isocyanate based material, epoxy based material, and materials based on melamine formaldehyde resin. The LENO tape 310 may also have a tackified finish, or green tack, applied for facilitating adhesion during the building process of a green tire. The selection of materials for the tackified finish may depend upon the materials selected for use in the tire. Tackified finishes may be achieved by various methods such as coating the fabric in an aqueous blend of rosin and rubber lattices, or with a solvent solution of an un-vulcanized rubber compound.

Further, the flipper 32a, 32b, 54 may comprise multiple layers 300, e.g. two, three, or even more layers, to provide extra strength for the flipper. When more than one layer 300 is used for the flipper 32a, 32b, 54, a layer of unvulcanized rubber may be placed between the layers to ensure an effective bond. The formation of the layer 300 may begin with the acquisition of the basic yarns for the fabric. Subsequently, the yarns may be twisted to provide additional mechanical resilience. After the twisting, the yarns 310, 320 may be placed on a large beam for the formation of the layer 300. The layer 300 may be formed knitting with the appropriate spacing of the yarns 310, 320. After the layer 300 formation, the layer may be finished with adhesive promoter, such as an RFL treatment. If a tackified finish is desired, this is provided following the adhesive promoter finishing. The final layer may be slit into the specific widths for placement on a spool.

The flipper 32a, 32b, 54 in accordance with the present invention improves prior art runflat and high performance tires by optimizing runflat mileage, high speed capability, and handling characteristics, without increasing manufacturing complexity. Additionally, the flipper 32a, 32b, 54 may reduce noise due to vibration damping in the bead area (i.e., circumferential reinforcement provided knitted layer 300). Further, the layer 300 need not be calendered and may be applied at the tire building machine (i.e., a spool of the layer 300 directly applied at the tire building machine). Also, the layer 300 may be applied symmetrically to both beads, or asymmetrically to only one bead. The width of the layer 300 may depend on specific design requirements. The yarns 310, 320 of the flipper 32b, 54 may be oriented radially or at an angle, such as in a range from 15 to 60 degrees, or more specifically from 30 to 55 degrees, with respect to the circumferential direction of the tire. The yarns 310, 320 may have a density of 5 EPI to 18 EPI.

As stated above, a flipper 32a, 32b, 54 in accordance with the present invention produces increased runflat mileage, high speed capability and handling characteristics, and vibration damping, without increasing manufacturing complexity. This flipper 32a, 32b, 54 thus enhances the performance of the pneumatic tire 10, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni. A pneumatic tire has certain essential structural elements. United States Department of Transportation, Mechanics of Pneumatic Tires, pages 207-208 (1981). An important structural element is the flipper/chipper, typically made up of many flexible, high modulus cords of natural textile, synthetic polymer, glass fiber, or fine hard drawn steel embedded in, and bonded to, a matrix of low modulus polymeric material, usually natural or synthetic rubber. Id. at 207 through 208.

The flexible, high modulus cords are usually disposed as layers. Id. at 208. Tire manufacturers throughout the industry cannot agree or predict the effect of different twists of cords on noise characteristics, handling, durability, comfort, etc. in pneumatic tires. Mechanics of Pneumatic Tires, pages 80 through 85.

These complexities are demonstrated by the below table of the interrelationships between tire performance and tire components.

| | | | FLIPPER | | | | |
|---|---|---|---|---|---|---|---|
| | LINER | CARCASS PLY | CHIPPER | BELT | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE COMFORT | X | X | X | | | X | |
| HIGH SPEED | | X | X | X | X | X | X |
| AIR RETENTION | X | | | | | | |
| MASS | X | X | X | X | X | X | X |

As seen in the table, flipper and chipper cord characteristics affect the other components of a pneumatic tire (i.e., flipper/chipper affects carcass ply, belt, overlay, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the insight, experimentation, and testing conducted by the inventors.

Thus, for example, when the structure (i.e., twist, cord construction, etc.) of the flipper fabric structure of a pneumatic tire is modified with the intent to improve one functional property of the pneumatic tire, any number of other functional properties may be unacceptably degraded. Furthermore, the interaction between the flipper and the carcass ply, belt, carcass, and tread may also unacceptably affect the functional properties of the pneumatic tire. A modification of the flipper fabric structure may not even improve that one functional property because of these complex interrelationships.

Thus, as stated above, the complexity of the interrelationships of the multiple components makes the actual result of modification of a flipper/chipper, in accordance with the present invention, impossible to predict or foresee from the infinite possible results. Only through extensive experimentation have the flipper 32a, 32b, 54 and knitted fabric structure of the present invention been revealed as an excellent, unexpected, and unpredictable option for a flipper.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire having an axis of rotation, the pneumatic tire comprising:
a carcass;
a tread disposed radially outward of the carcass;
a belt structure disposed radially between the carcass and the tread; and
a reinforcing structure providing a buffer for absorbing shear strain, the reinforcing structure comprising a layer of a knitted fabric, the layer comprising first yarns and second yarns.

2. The pneumatic tire of claim 1 wherein the reinforcing structure of the carcass is a flipper.

3. The pneumatic tire of claim 2 wherein the flipper separates a reinforced ply of the carcass from a bead of the carcass.

4. The pneumatic tire of claim 3 wherein the flipper acts as a strain-relieving layer between the bead and the reinforced ply.

5. The pneumatic tire of claim 1 wherein the fabric has a 5 EPI to 18 EPI construction.

6. The pneumatic tire of claim 5 wherein the first yarns are 940/1 dtex polyaramide and the second yarns are 1220/1 dtex rayon.

7. The pneumatic tire of claim 6 wherein the first yarns have a density of 14 EPI and the second yarns have a density of 12 EPI.

8. The pneumatic tire of claim 1 wherein the pneumatic tire is a radial runflat passenger tire.

9. The pneumatic tire of claim 1 wherein the pneumatic tire is a high performance tire.

10. The pneumatic tire of claim 1 wherein the layer further comprises an adhesion promoter disposed thereon.

11. The pneumatic tire of claim 1 wherein the reinforcing structure of the carcass is a flipper having two or more layers.

12. The pneumatic tire of claim 11 wherein the flipper includes a layer of rubber between the fabric layers.

13. The pneumatic tire of claim 1 wherein the first yarns comprise at least two fibers of different fiber materials.

14. The pneumatic tire of claim 1 wherein the second yarns comprise at least two fibers of different fiber materials.

15. The pneumatic tire of claim 1 wherein the first yarns extend circumferentially and radially at an angle of 30 degrees to 55 degrees relative to the radial direction of the tire.

16. The pneumatic tire of claim 1 wherein the reinforcing structure separates a reinforced ply of the carcass from a bead of the carcass, the reinforcing structure terminating within an apex of the pneumatic tire.
